(19) United States
(12) Patent Application Publication
(10) Pub. No.: US 2024/0253268 A1
(43) Pub. Date: Aug. 1, 2024

(54) BIMODAL CEMENTED CARBIDE POWDERS FOR ADDITIVE MANUFACTURING AND STRUCTURED BODIES MADE THEREFROM

(71) Applicant: Kennametal Inc., Latrobe, PA (US)

(72) Inventors: Zhuqing Wang, Greensburg, PA (US); Paul D. Prichard, Greensburg, PA (US); Hadi Miyanaji, Murrysville, PA (US)

(21) Appl. No.: 18/102,517

(22) Filed: Jan. 27, 2023

(51) Int. Cl. B28B 1/00; C04B 35/56; C04B 35/626; C04B 35/63; C04B 35/645; C04B 41/00

(52) U.S. Cl. CPC B28B 1/001; C04B 35/5626; C04B 35/6261; C04B 35/62625; C04B 35/62655; C04B 35/6303; C04B 35/6455; C04B 41/0072; C04B 2235/3847; C04B 2235/405; C04B 2235/66

(57) ABSTRACT

Sintered cemented carbide powder compositions are disclosed for use in the production of various articles by additive manufacturing. The individual particles of the powder compositions comprise metal carbide particles sintered together with a metallic binder. The sintered cemented carbide particles comprise at least a bimodal size distribution in which the first mode comprising spherical sintered cemented carbide particles having a D50 of 15 μm to 45 μm and the second mode comprises non-spherical cemented carbide particles having a D50 of 5 μm to 15 μm. The metallic binder may be present in an amount of from 9 to 11 weight percent based on total weight of the sintered cemented carbide particles. Sintered cemented carbide bodies additively manufactured from the sintered cemented carbide powder compositions are disclosed. Methods of making the sintered cemented carbide powder compositions and methods of making the sintered cemented carbide bodies are also disclosed.

### FIELD OF THE INVENTION

The present invention relates to cemented carbide powder compositions used in additive manufacturing and sintered cemented carbide bodies additively manufactured with the cemented carbide powders.

### BACKGROUND INFORMATION

Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process. Most importantly, additive manufacturing enables significant freedom in article design. Articles having highly complex shapes can be produced without significant expense allowing the development and evaluation of a series of article designs prior to final design selection.

### SUMMARY OF THE INVENTION

Sintered cemented carbide powder compositions are provided for use in the production of various articles by additive manufacturing. The individual particles of the powder compositions comprise metal carbide particles sintered together with a metallic binder. The sintered cemented carbide particles comprise at least a bimodal size distribution in which the first mode comprises spherical sintered cemented carbide particles having a D50 of 15 μm to 45 μm and the second mode comprises non-spherical sintered cemented carbide particles having a D50 of 5 μm to 15 μm. The metallic binder may be present in an amount of from 9 to 11 weight percent based on total weight of the sintered cemented carbide particles. Sintered cemented carbide bodies additively manufactured from the sintered cemented carbide powder compositions are provided. Methods of making the sintered cemented carbide powder compositions and methods of making the sintered cemented carbide bodies are also provided.

Disclosed herein is a powder composition for binder jet printing comprising sintered cemented carbide particles comprising a first mode comprising sintered cemented carbide particles having a D50 of from 15 μm to 45 μm and a second mode comprising sintered cemented carbide particles having a D50 of from 5 μm to 15 μm, wherein the sintered cemented carbide particles comprise from 9 to 11 weight percent of a metallic binder based on total weight of the sintered cemented carbide particles.

Also disclosed herein is a method of making a powder composition for binder jet printing comprising forming a slurry by milling metal carbide particles and from 9 to 11 weight percent of a metallic binder based on total weight of the slurry; spray drying the slurry to form a powder; sintering a first portion of the powder; milling and sieving the first portion of the powder to a D50 of from 15 μm to 45 μm; and sintering the first portion of the powder for a second time in a partial liquid state to form a first mode; forming a second mode by milling a second portion of the powder form non-spherical cemented carbide particles having a D50 of from 5 μm to 15 μm; and combining the first mode and the second mode.

Also disclosed herein is a binder jet printed sintered cemented carbide body comprising sintered cemented carbide particles comprising a first mode comprising spherical sintered cemented carbide particles having a D50 of from 15 μm to 45 μm and a second mode comprising non-spherical sintered cemented carbide particles having a D50 of from 5 μm to 15 μm, wherein the sintered cemented carbide particles comprise from 9 to 11 weight percent of a metallic binder based on total weight of the sintered cemented carbide particles, and the sintered cemented carbide body has a theoretical density percentage equal to or greater than 99%. The binder jet printed sintered cemented carbide body is formed by binder jet printing the sintered cemented carbide particles to form a green body, followed by sintering the green body.

Also disclosed herein is a method of forming a sintered cemented carbide body comprising: binder jet printing a powder composition comprising sintered cemented carbide particles comprising a first mode comprising spherical sintered cemented carbide particles having a D50 of from 15 μm to 45 μm and a second mode comprising non-spherical sintered cemented carbide particles having a D50 of from 5 μm to 15 μm, wherein the sintered cemented carbide particles comprise from 9 to 11 weight percent of a metallic binder based on total weight of the sintered cemented carbide particles, and the sintered cemented carbide body has a theoretical density percentage equal to or greater than 99% and a printing binder to form a green body; and sintering the green body to provide the sintered cemented carbide body.

### BRIEF DESCRIPTION OF THE DRAWINGS

FIG. 1 is a scanning electron microscopy (SEM) image of a cross section of a sample of the GU1 powder.

FIG. 2 is an SEM of a cross section of a sample of the C2 powder.

FIG. 3 is an SEM of a cross section of the F1 powder.

FIG. 4 is a microstructure of sintered Sample 1.

FIG. 5 is a microstructure of sintered Sample 2.

FIG. 6 is a microstructure of sintered Sample 3.

### DETAILED DESCRIPTION

The invention disclosed herein is directed to powder compositions for binder jet printing comprising sintered cemented carbide particles comprising a first mode comprising spherical sintered cemented carbide particles having a D50 of from 15 μm to 45 μm and a second mode comprising non-spherical sintered cemented carbide particles having a D50 of from 5 μm to 15 μm, wherein the sintered cemented carbide particles comprise from 9 to 11 weight percent of a metallic binder based on total weight of the sintered cemented carbide particles.

The powder compositions may be used in any suitable additive manufacturing technique to form a three-dimensional part. The term “additive manufacturing technique” refers to processes for forming a three-dimensional object by successively adding material to the object layer by layer. The layer-by-layer, stratified construction makes it possible to easily form undercuts and complex geometrical structures, which, with previous conventional manufacturing methods, was not possible or required considerable effort and expense. The three-dimensional object may be based upon a 3D model of the component object that may be electronically designed as an electronic file having the design parameters. Additive manufacturing may also be referred to as 3D printing. The additive manufacturing technique of the invention comprises a process for forming a ceramic powder into the sintered cemented carbide body.

The additive manufacturing process may comprise, for example, binder jetting. As used herein, “binder jetting” or “binder jet” refers to the following method of producing a component: selectively jetting droplets of liquid binder onto a bed of powder (e.g., a ceramic powder) based on a 3D model of a component, adhering particles into a cross-section, depositing additional powder then binder to form the next layer of the object and repeating this process until the green component is finished. For example, the binder jetting apparatus spreads a layer of the metal, ceramic, or cermet powder in a build box, a printhead moves over the powder layer depositing liquid binder according to design parameters for that layer, the layer is dried, the build box is lowered, a new layer of ceramic powder is spread, and the process is repeated until the green article (body) is completed. Although binder jetting is primarily described herein as the additive manufacturing process for making the present materials, other types of additive processes may be adapted for use herein.

The sintered cemented carbide particles comprise individual metal carbide grains sintered and bound together by a metallic binder.

The sintered cemented carbide particles comprise one or more metal carbides. The metal carbides may comprise Group IVB metal carbides, Group VB metal carbides, Group VIB metal carbides, or combinations thereof. For example, the sintered cemented carbide particles may comprise tungsten carbide, chromium carbide, titanium carbide, vanadium carbide, tantalum carbide, niobium carbide, zirconium carbide, and/or hafnium carbide. The sintered cemented carbide particles may comprise tungsten carbide and a second metal carbide. The tungsten carbide may be present in an amount of at least 85 to 90 weight percent based on total weight of the sintered cemented carbide particles. If present, the second metal carbide may be present in an amount of 0.1 to 5 weight percent based on total weight of the sintered cemented carbide particles.

The sintered cemented carbide particles may not comprise multiple metal and/or non-stoichiometric metal carbides. Double and/or lower metal carbides include but are not limited to, eta phase (Co₃W₃C or Co₆W₆C), W₂C and/or W₃C. Additionally, the sintered cemented carbide particles may exhibit uniform or substantially uniform microstructure.

The sintered cemented carbide particles comprise a metallic binder. The metallic binder may comprise cobalt, cobalt alloys, nickel, nickel alloys, iron, iron alloys, or a combination thereof. The metallic binder may further comprise one or more additives, such as noble metal additives. Examples of noble metal additives that may be used in the present invention include but are not limited to platinum, palladium, rhenium, rhodium, and ruthenium, and alloys thereof. Other additives include molybdenum, silicon, or combinations thereof. If present at all, additives may be present in the metallic binder in an amount of from 0.1 to 10 weight percent of the sintered cemented carbide particles based on total weight of the sintered cemented carbide particles.

The metallic binder may be present in the sintered cemented carbide particles in an amount of at least 9 weight percent based on total weight of the sintered cemented carbide particles, such as at least 9.1 weight percent, such as at least 9.5 weight percent, such as at least 9.8 weight percent. The metallic binder may be present in the sintered cemented carbide particles in an amount of no more than 11 weight percent based on total weight of the sintered cemented carbide particles, such as no more than 10.9 weight percent, such as no more than 10.5 weight percent, such as no more than 10.2 weight percent. The metallic binder may be present in the sintered cemented carbide particles in an amount of from 9 to 11 weight percent based on total weight of the sintered cemented carbide particles, such as from 9.1 to 10.9 weight percent, such as from 9.5 to 10.5 weight percent, such as from 9.8 to 10.2 weight percent. The metallic binder may be present in the sintered cemented carbide particles in an amount of 10 weight percent based on total weight of the sintered cemented carbide particles.

As previously stated, the sintered cemented carbide particles comprise a first mode. The first mode may comprise substantially spherical particles. As used herein, “spherical” means that the particles are generally sphere-shaped, having convexly curved outer surfaces with substantially no flat or concave surface areas, and an aspect ratio of 1:1.

The first mode particles may have a D50 of at least 15 μm, such as at least 20 μm, such as at least 25 μm, such as at least 27 μm. The first mode particles may have a D50 of no more than 45 μm, such as no more than 40 μm, such as no more than 35 μm, such as no more than 30 μm. The first mode particles may have a D50 of from 15 μm to 45 μm, such as from 20 μm to 40 μm, such as from 25 μm to 35 μm, such as from 27 μm to 30 μm. As used herein, “D50” means the point in the size distribution in which 50 percent or more of the total volume of material in the sample is contained. For example, a D50 of 15 μm means that 50 percent of the particles of the sample have a size smaller than 15 μm.

The first mode particles may have a D10 of at least 10 μm, such as at least 12 μm, such as at least 15 μm. The first mode particles may have a D10 of no more than 25 μm, such as no more than 23 μm, such as no more than 20 μm. The first mode particles may have a D10 of from 10 μm to 25 μm, such as from 12 μm to 23 μm, such as from 15 μm to 20 μm. As used herein, “D10” means the point in the size distribution in which 10 percent or more of the total volume of material in the sample is contained. For example, a D10 of 10 μm means that 10 percent of the particles of the sample have a size of 10 μm or smaller.

The first mode particles may have a D90 of at least 25 μm, such as at least 30 μm, such as at least 35 μm. The first mode particles may have a D90 of no more than 55 μm, such as no more than 50 μm, such as no more than 45 μm. The first mode particles may have a D90 of from 25 μm to 55 μm, such as from 30 μm to 50 μm, such as from 35 μm to 45 μm. As used herein, “D90” means the point in the size distribution in which 90 percent or more of the total volume of material in the sample is contained. For example, a D90 of 25 μm means that 90 percent of the particles of the sample have a size smaller than 25 μm.

Powder size distributions described and claimed herein may be measured using a laser diffraction particle size analyzer (S-3500, commercially available from Microtrac MRB).

The first mode particles may have an average individual particle porosity of no more than 10 volume percent, such as no more than 8 volume percent, such as no more than 6 volume percent. As used herein, “individual particle porosity” refers to the volume percent of pores in an individual particle based upon the total volume of the particle. That is, if an individual particle has a particle porosity of 10 volume percent, 90 volume percent of the particle comprises material, such as, for example, metal carbides and/or metallic binder.

The first mode particles may be present in the powder composition in an amount of greater than 60 weight percent based on total weight of the powder composition, such as at least 62 weight percent, such as at least 65 weight percent. The first mode particles may be present in the powder composition in an amount of less than 75 weight percent based on total weight of the powder composition, such as no more than 73 weight percent, such as no more than 70 weight percent. The first mode particles may be present in the powder composition in an amount of from greater than 60 to less than 75 weight percent based on total weight of the powder composition, such as from 62 to 73 weight percent, such as from 65 to 70 weight percent.

The sintered cemented carbide particles comprise a second mode. The second mode may comprise non-spherical particles. As used herein, “non-spherical” means that the particles are not sphere-shaped, but may comprise planar surfaces or faceted surfaces. The edges may have concave portions. Non-spherical particles may or may not have a 1:1 aspect ratio, e.g., at least a portion of the particles may have an aspect ratio of greater than 1:1, such as greater than 1.1:1, such as greater than 1.2:1, such as greater than 1.5:1.

The second mode particles may be formed by milling the first mode particles to make smaller sized particles.

The second mode particles may have a D50 of at least 5 μm, such as at least 6 μm, such as at least 8 μm. The second mode particles may have a D50 of no more than 15 μm, such as no more than 12 μm, such as no more than 10 μm. The second mode particles may have a D50 of from 5 μm to 15 μm, such as from 6 μm to 12 μm, such as from 8 μm to 10 μm.

The second mode particles may have a D10 of at least 0.5 μm, such as at least 1 μm, such as at least 1.5 μm. The second mode particles may have a D10 of no more than 5 μm, such as no more than 3 μm, such as no more than 2 μm. The second mode particles may have a D10 of from 0.5 μm to 5 μm, such as from 1 μm to 3 μm, such as from 1.5 μm to 2 μm.

The second mode particles may have a D90 of at least 10 μm, such as at least 12 μm, such as at least 15 μm. The second mode particles may have a D90 of no more than 30 μm, such as no more than 25 μm, such as no more than 20 μm. The second mode particles may have a D90 of 10 μm to 30 μm, such as 12 μm to 25 μm, such as 15 μm to 20 μm.

The second mode particles may have an average individual particle porosity of no more than 20 volume percent, such as no more than 18 volume percent, such as no more than 15 volume percent.

The second mode particles may be present in the powder composition in an amount of greater than 25 weight percent based on total weight of the powder composition, such as at least 27 weight percent, such as at least 30 weight percent. The second mode particles may be present in the powder composition in an amount of less than 40 weight percent based on total weight of the powder composition, such as no more than 38 weight percent, such as no more than 35 weight percent. The second mode particles may be present in the powder composition in an amount of from greater than 25 to less than 40 weight percent based on total weight of the powder composition, such as from 27 to 38 weight percent, such as from 30 to 35 weight percent.

The powder composition may have a theoretical density percentage of at least 99%, such as at least 99.1%, such as at least 99.2%, such as at least 99.3%, such as at least 99.5%. The theoretical density percentage is calculated by dividing the sintered HIP density as measured by ASTM B311 by a theoretical density. As used herein, “theoretical density” means the maximum achievable density of a sample.

The powder composition may have a tap density of at least 6.5 g/cm³, such as at least 6.7 g/cm³, such as at least 6.8 g/cm³, such as at least 6.9 g/cm³. The powder composition may have a tap density of no more than 8.0 g/cm³, such as no more than 7.5 g/cm³, such as no more than 7.3 g/cm³, such as no more than 7.2 g/cm³. The powder composition may have a tap density of from 6.5 g/cm³ to 8.0 g/cm³, such as from 6.7 g/cm³ to 7.5 g/cm³, such as from 6.8 g/cm³ to 7.3 g/cm³, such as from 6.9 g/cm³ to 7.2 g/cm³. As used herein, “tap density” means the mass of a unit volume of powder once the powder has been tapped for a defined number of tap cycles. Tap density can be determined according to ASTM B527 Standard Test Method for Tap Density of Metal Powders and Compounds.

The powder composition may have an apparent density of at least 5.0 g/cm³, such as at least 5.2 g/cm³, such as at least 5.3 g/cm³. The powder composition may have an apparent density of no more than 6.0 g/cm³, such as no more than 5.8 g/cm³, such as no more than 5.6 g/cm³. The powder composition may have an apparent density of from 5.0 g/cm³ to 6.0 g/cm³, such as from 5.2 g/cm³ to 5.8 g/cm³, such as from 5.3 g/cm³ to 5.6 g/cm³. As used herein, “apparent density” means the mass of a unit volume of powder or particles in the loose condition. Apparent density may also be called bulk density. Apparent density can be determined according to ASTM B212 Standard Test Method for Apparent Density of Free-Flowing Metal Powders using the Hall Flowmeter Funnel.

The ratio of the tap density to the apparent density (“Hausner ratio”) of the powder composition may be at least 1.18, such as at least 1.19, such as at least 1.20. The Hausner ratio of the powder composition may be no more than 1.30, such as no more than 1.29, such as no more than 1.28. The Hausner ratio of the powder composition may be from 1.18 to 1.30, such as from 1.19 to 1.29, such as from 1.28 to 1.28.

When the carbide comprises tungsten carbide and the metallic binder comprises cobalt, the powder composition may have a sintered density of at least 14.30 g/cm³, such as at least 14.31 g/cm³, such as at least 14.32 g/cm³, such as at least 14.33 g/cm³. The powder composition may have a sintered density of no more than 14.40 g/cm³, such as no more than 14.38 g/cm³, such as no more than 14.37 g/cm³, such as no more than 14.36 g/cm³. The sintered density of the powder composition may be from 14.30 g/cm³ to 14.40 g/cm³, such as from 14.31 g/cm³ to 14.38 g/cm³, such as from 14.32 g/cm³ to 14.37 g/cm³, such as from 14.33 g/cm³ to 14.36 g/cm³. The sintered density may be measured by ASTM B311 Density Determination for Powder Metallurgy (P/M) Materials Containing Less Than Two Percent Porosity.

The present invention is further directed to a method of making a powder composition for binder jet printing comprising forming a slurry by milling metal carbide particles and from 9 to 11 weight percent of a metallic binder based on total weight of the slurry; spray drying the slurry to form a powder; sintering a first portion of the powder; milling and sieving the first portion of the powder to a D50 of from 15 μm to 45 μm; and sintering the first portion of the powder for a second time in a partial liquid state to form a first mode; forming a second mode by milling a second portion of the powder to form non-spherical cemented carbide particles having a D50 of from 5 μm to 15 μm; and combining the first mode and the second mode.

The densities and individual particle porosities of the powder composition disclosed herein can be achieved through one or several sintering processes administered to the particles. The sintering processes may not employ sintering inhibitor(s) to mitigate particle stick or adhesion. Sintered cemented carbide particle properties described herein can be achieved in the absence of sintering inhibitor(s). Sintered cemented carbide particles may be prepared by sintering a grade powder composition at temperatures of from 1100° C. to 1400° C. for from 0.5 to 2 hours to provide a sintered compact. The sintered compact is subsequently milled to provide individual sintered cemented carbide particles. Depending on particle morphology and density, the sintered cemented carbide particles can be further heat treated for further densification. Further heat treatment can include plasma densification, such as plasma spheroidization using an RF plasma torch or DC plasma torch. Alternatively, the sintered cemented carbide particles can be re-sintered forming a second compact. The second compact is milled to provide the sintered cemented carbide particles. Any desired number of additional densification treatments can be administered to provide sintered cemented carbide particles having the desired apparent density, tap density, and/or individual particle density. Sintering times and temperatures can be selected according to several considerations including, but not limited to, binder content of the cemented carbide particles, desired sintered particle density and sintering stage. In some embodiments, early sintering stages are conducted at lower temperatures and/or shorter times to facilitate milling the sintered compact. For example, an initial or early-stage sintering process may be administered at temperatures below binder liquefaction. Late stage or final sintering processes may achieve higher temperatures, such as temperatures at which liquid phase sintering takes place.

The present invention is further directed to a binder jet printed sintered cemented carbide body comprising sintered cemented carbide particles comprising a first mode comprising spherical sintered cemented carbide particles having a D50 of from 15 μm to 45 μm and a second mode comprising non-spherical sintered cemented carbide particles having a D50 of from 5 μm to 15 μm, wherein the sintered cemented carbide particles comprise from 9 to 11 weight percent of a metallic binder based on total weight of the sintered cemented carbide particles, and the sintered cemented carbide body has a theoretical density percentage equal to or greater than 99%.

When the sintered cemented carbide body comprises tungsten carbide and cobalt binder metal in the amounts disclosed herein, it may have a sintered density equal to or greater than 14 g/cm³, such as at least 14.1 g/cm³, such as at least 14.2 g/cm³, such as at least 14.3 g/cm³, such as about 14.4 g/cm³. The sintered density may be measured by ASTM B311 Density Determination for Powder Metallurgy (P/M) Materials Containing Less Than Two Percent Porosity.

The sintered cemented carbide body may have a theoretical density percentage of equal to or greater than 99%, such as greater than 99.1%, such as greater than 99.3%, such as greater than 99.5%, such as greater than 99.7%, such as greater than 99.9%. Theoretical density percentage is calculated as set forth herein above.

The sintered cemented carbide body may have a sinter porosity rating of A02B00C00, A01B00C00, or A00B00C00. The sintered density may be determined by the procedures of ASTM B276: Standard Test Method for Apparent Porosity in Cemented Carbides Active Only.

The invention is further directed to a method of forming a sintered cemented carbide body comprising: binder jet printing a powder composition comprising sintered cemented carbide particles comprising a first mode comprising spherical sintered cemented carbide particles having a D50 of from 15 μm to 45 μm and a second mode comprising non-spherical sintered cemented carbide particles having a D50 of from 5 μm to 15 μm, wherein the sintered cemented carbide particles comprise from 9 to 11 weight percent of a metallic binder based on total weight of the sintered cemented carbide particles, and the first mode and the second mode are present in a weight ratio of from 1:9 to 3:2, and the sintered cemented carbide body has a theoretical density percentage equal to or greater than 99% and a printing binder to form a green body; and sintering the green body to provide the sintered cemented carbide body.

The method for forming a sintered cemented carbide body may comprise sintering the green body by a sinter-HIP process. The green body may be formed from any of the powder compositions described herein above.

A green body is formed by binder jet printing one of the power compositions described herein and a printing binder. Any organic binder known in the art may be used as the printing binder. In examples, the organic binder may comprise one or more polymeric materials, such as polyvinylpyrrolidone (PVP), polyethylene glycol (PEG), or mixtures thereof. The organic binder may be curable which can enhance the strength of the green article. The polymeric binder may be an aqueous binder or a solvent binder. The green articles may exhibit a binder saturation of at least 80%, such as 100%, or greater than 100%.

The green body may then be sintered under conditions and for time periods adequate to provide sintered bodies having the desired density. The green article can be vacuum sintered or sintered under a hydrogen or argon atmosphere at temperatures of from 1300° C. to 1560° C. Moreover, sintering times can generally range from 10 minutes to 5 hours. Hot isostatic pressing (HIP) may optionally be added to the sintering process. HIP may be administered as a post-sinter operation or during vacuum sintering. Hot isostatic pressing can be administered for up to 2 hours at pressures of from 1 MPa to 300 MPa and temperatures of from 1300° C. to 1560° C. Microstructures of the sintered cemented carbide bodies may be uniform. The sintered cemented carbide bodies may exhibit a volume shrinkage in the sintered samples compared to as-printed samples of from 40 to 60 volume percent.

Sintered cemented carbide bodies produced according to the methods described herein can be employed in a variety of industries including petrochemical, automotive, aerospace, industrial tooling, metal cutting tools, and manufacturing. The sintered cemented carbide bodies may be used as components exposed to wear environments or abrasive operating conditions such as flow control components, pumps, bearings, valves, valve components, centrifuge components, disk stacks, and/or fluid handling components. The sintered cemented carbide body can also comprise one or more internal fluid flow channels formed by the additive manufacturing technique. The sintered cemented carbide body may be near-net shape and/or require minimal post sintering processing to place the bodies in final form.

### Examples

Spherical porous coarse powder (C1) was produced by milling a mixture of 90 wt. % tungsten carbide (WC) particle, 10 wt. % cobalt (Co) powder, and organic additives. Then the slurry was spray dried and sintered in vacuum (<10⁻³ torr) in the solid state at 1200-1250° C. for 1 to 2 hours, forming lightly sintered powder. The sintered powder was milled and sieved to the desired powder size distribution. Spherical dense coarse powder (C2) was produced by re-sintering C1 powder in vacuum (<10-3 torr) in a partial liquid state at 1260-1320° C. for 1-2 hours to increase the density. Non-spherical porous fine powder, F1, was produced by ball milling C1 powder for 10 hours. After milling, the powder size was reduced significantly, but the porosity level remained similar compared to GU1.

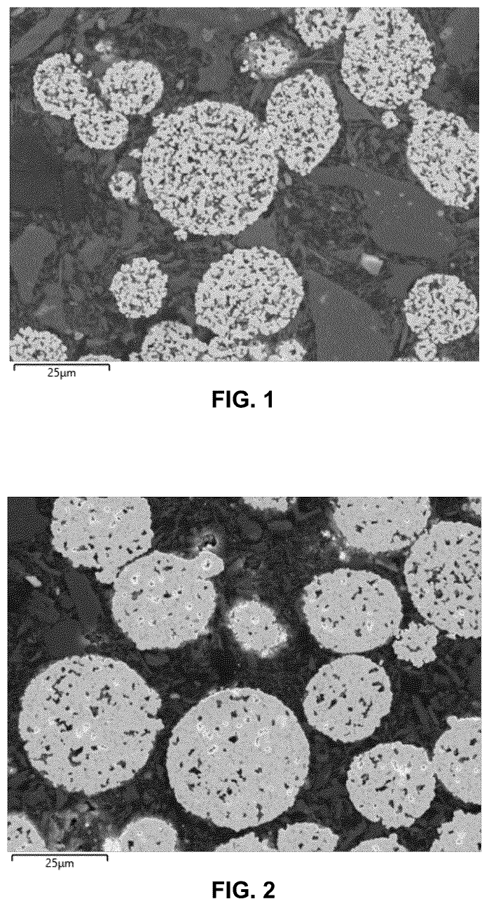

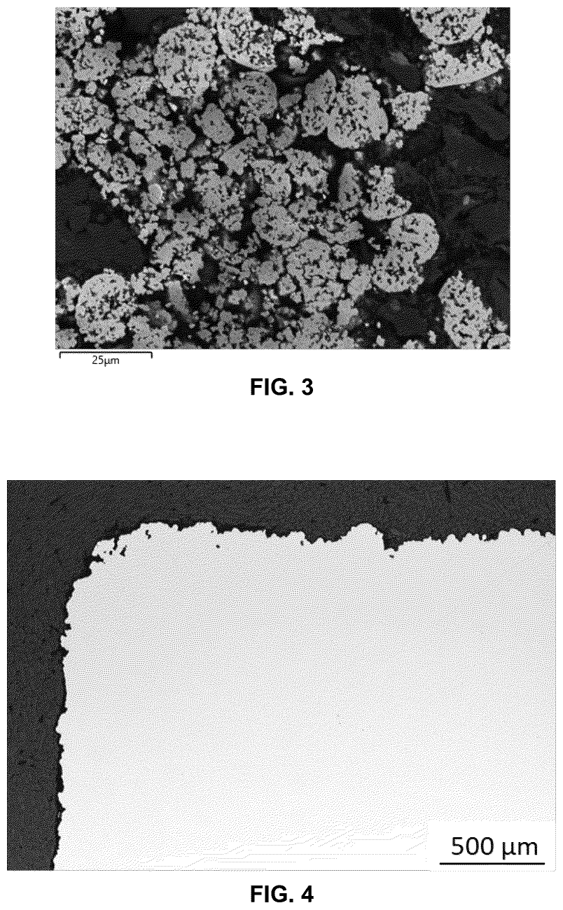

Table 1 shows the powder size distribution (D10, D50, and D90), porosity, and shape of C1, C2, and F1 powders. Powder size distribution was measured by laser scattering method using a laser diffraction particle size analyzer (S-3500, commercially available from Microtrac MRB). Powder samples were mounted, polished, and imaged to characterize porosity and morphology. Scanning electron micrograph (SEM) of C1, C2, and F1 powder cross sections are given in FIGS. 1, 2, and 3, respectively. Image processing software, Image J, was applied to the SEM images to compute porosity.

TABLE 1
Properties of WC—10Co powders

| | Co | D10 | D50 | D90 | Porosity | |
|---|---|---|---|---|---|---|
| Powder | (wt. %) | (μm) | (μm) | (μm) | (%) | Shape |
| C1 | 10.0 | 20.5 | 30.0 | 42.5 | 15 | Spherical |
| C2 | 10.0 | 18.9 | 28.1 | 40.1 | 6 | Spherical |
| F1 | 10.0 | 1.7 | 9.2 | 19.4 | 13 | Non-spherical |

Eight batches of bimodal powder mixture were examined. The samples were prepared in 100 g batches by mixing in sealed cylindrical glass jars. The sealed jars were oriented lying downside on a vibrational table. The table was vibrated at 100 Hz to 300 Hz for at least 5 minutes to allow thorough mixing of the powders. 11 g of bimodal powder of each batch was put into a graphite crucible coated with a graphite-based parting agent and tapped 300 times. The crucibles with powder were sintered using a sinter-HIP vacuum furnace at a temperature of 1441° C. and a pressure of 5.5 MPa in Ar atmosphere for 45 minutes. The target minimum sintered density is 14.33 g/cm³ or 99.5% of the theoretical density. The results are provided in Table 2. As shown, the density decreased with the increase in weight percent of GU2 powder. Batches comprising 70% or less GU2 powder exhibited excellent sintered density.

Sintered density was determined using Archimedes procedure described in ASTM B311. Apparent density was measured according to ASTM B212 Standard Test Method for Apparent Density of Free-Flowing Metal Powders using the Hall Flowmeter Funnel. Tap density was measured according to ASTM B527 Standard Test Method for Tap Density of Metal Powders and Compounds. Particle size was measured as described herein above.

TABLE 2
Properties of bimodal powder mixtures

| | | | | | | | | | Sintered | |
|---|---|---|---|---|---|---|---|---|---|---|
| | | | | | | | | | density of | |
| | | | Apparent | Tap | | | | | tapped | Theoretical |
| Batch | C2 | F1 | density | density | Hausner | D10 | D50 | D90 | powder | density |
| No. | (wt. %) | (wt. %) | (g/cm³) | (g/cm³) | ratio | (μm) | (μm) | (μm) | (g/cm³) | percentage¹ |
| 1 | 10 | 90 | 4.20 | 5.90 | 1.4 | 4.92 | 15.49 | 25.85 | 14.35 | 99.5% |
| 2 | 30 | 70 | 4.57 | 6.17 | 1.35 | 5.87 | 17.62 | 31.55 | 14.34 | 99.4% |
| 3 | 50 | 50 | 5.05 | 6.62 | 1.31 | 7.87 | 21.54 | 36.06 | 14.33 | 99.4% |
| 4 | 60 | 40 | 5.26 | 6.66 | 1.27 | 10.25 | 23.31 | 38.27 | 14.36 | 99.6% |
| 5 | 65 | 35 | 5.51 | 7.00 | 1.27 | 10.84 | 24.89 | 38.14 | 14.35 | 99.5% |
| 6 | 70 | 30 | 5.34 | 7.17 | 1.34 | 11.36 | 25.22 | 38.96 | 14.35 | 99.5% |
| 7* | 75 | 25 | 5.48 | 7.05 | 1.29 | 13.26 | 25.96 | 39.13 | 14.09 | 97.7% |
| 8* | 80 | 20 | 5.55 | 7.04 | 1.27 | 13.07 | 26.06 | 39.21 | 13.96 | 96.8% |

*Comparative Sample
¹Reference density: 14.42 g/cm³

Blocks of 25 mm×25 mm×12 mm were printed from bimodal powder batches 4, 5, 6, and 7 using a binder jetting machine “Desktop P1” with SPJ-04 binder. The binder droplet size was approximately 20 pL. The layer thickness was 50-60 μm and the binder saturation was 30% to 45%.

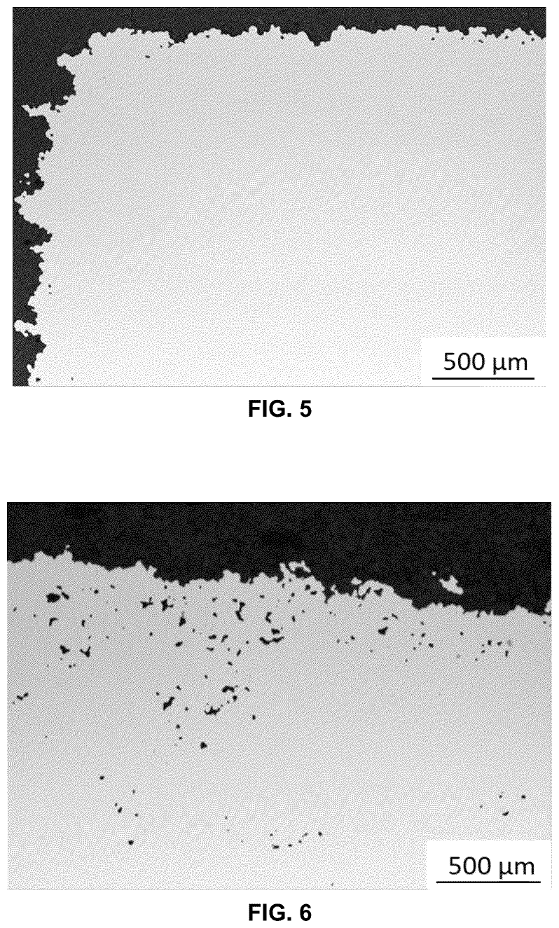

The samples were cured at 195° C. for 4 hours in a curing oven in Ar atmosphere. After curing, depowdering was performed by removing the surrounding unbounded powder using vacuum. Samples from batches 5, 6, and 7 were able to be depowdered, but samples from batch 4 were unable to be depowdered due to too much fine powder in the mixture. The blocks were then put on graphite trays coated with a graphite-based parting agent for debinding and sintering in a sinter-HIP furnace. In the debinding step, samples were heated to 538° C. in hydrogen atmosphere. In the subsequent sintering step, samples were sintered at a temperature of 1510° C. and a pressure of 5.5 MPa in Ar atmosphere for 45 minutes. A shrinkage of 50 to 60 volume percent were observed in the sintered samples compared to the as-printed samples. The properties of the as-printed and sintered samples are provided in Table 3. The representative microstructures of Samples 1, 2, and 3 are provided in FIGS. 4, 5, and 6, respectively. The results show that samples are nearly fully dense when the powder composition used comprises 30 weight percent or more of the fine powder. However, when the amount of fine powder drops to 25 weight percent, the sintered sample exhibits poor performance.

TABLE 3
Properties of WC—10Co samples printed using bimodal powder mixtures

| | | | | Sintered | | |
|---|---|---|---|---|---|---|
| | | | | Density | | |
| | | Binder | Green | of printed | Theoretical | |
| | | saturation | density | sample | density | |
| | Powder | (%) | (g/cm³) | (g/cm³) | percentage¹ | Porosity |
| Sample 1 | Batch 5 | 30 | 6.03 | 14.38 | 99.7 | A00B00C000 |
| Sample 2 | Batch 6 | 45 | 6.05 | 14.38 | 99.7 | A02B00C00 |
| Sample 3 | Batch 7 | 45 | 5.88 | 14.27 | 99.0 | Approximately 1% |

¹Reference density: 14.42 g/cm³

For purposes of this detailed description, it is to be understood that the invention may assume various alternatives and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “from 1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses singular, unless specifically stated otherwise. For example, although reference is made herein to “a” powder composition, “a” cemented carbide body, and “an” apparent density, a combination (i.e., a plurality) of these components may be used.

In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A powder composition for binder jet printing comprising sintered cemented carbide particles comprising:
a first mode comprising spherical cemented carbide particles having a D50 of from 15 μm to 45 μm; and
a second mode comprising non-spherical cemented carbide particles having a D50 of from 5 μm to 15 μm, wherein the sintered cemented carbide particles comprise from 9 to 11 weight percent of a metallic binder based on total weight of the sintered cemented carbide particles.

2. The powder composition of claim 1, wherein the sintered cemented carbide particles comprise tungsten carbide and the metallic binder comprises cobalt.

3. The powder composition of claim 1, wherein the powder composition has a sintered density of at least 14.3 g/cm³.

4. The powder composition of claim 1, wherein the metallic binder is present in an amount of from 9.5 to 10.5 weight percent based on total weight of the sintered cemented carbide particles.

5. The powder composition of claim 1, wherein the first mode has a D10 of from 10 μm to 25 μm.

6. The powder composition of claim 1, wherein the first mode has a D90 of from 25 μm to 55 μm.

7. The powder composition of claim 1, wherein the first mode has a particle porosity of no more than 10 volume percent.

8. The powder composition of claim 1, wherein the first mode comprises spherical sintered cemented carbide particles.

9. The powder composition of claim 1, wherein the second mode has a D10 of from 0.5 μm to 5 μm.

10. The powder composition of claim 1, wherein the second mode has a D90 of 10 μm to 30 μm.

11. The powder composition of claim 1, wherein the second mode has a particle porosity of no more than 20 volume percent.

12. The powder composition of claim 1, wherein the second mode comprises non-spherical sintered cemented carbide particles.

13. The powder composition of claim 1, wherein the sintered cemented carbide body comprises from greater than 60 to less than 40 weight percent of the first mode based on total weight of the sintered cemented carbide body.

14. The powder composition of claim 1, wherein the sintered cemented carbide body comprises from greater than 25 to less than 40 weight percent of the first mode based on total weight of the sintered cemented carbide body.

15. The powder composition of claim 1, wherein the powder composition has a tap density of at least 6.5 g/cm³.

16. The powder composition of claim 1, wherein the powder composition has an apparent density of at least 5.0 g/cm³.

17. The powder composition of claim 1, wherein the powder composition has a Hausner ratio of from 1.18 to 1.30.

18. The powder composition of claim 1, wherein the powder composition has a theoretical density percentage of at least 99.0%.

19. A method of making the powder composition of claim 1 comprising:
milling metal carbide particles and the metallic binder to form a slurry; spray drying the slurry to form a powder; sintering a first portion of the powder; milling and sieving the first portion of the powder; and sintering the first portion of the powder for a second time in a partial liquid state to form the first mode;
forming the second mode by milling a second portion of the powder; and
combining the first mode and the second mode.

20. A method of making a powder composition for binder jet printing comprising:
forming a slurry by milling metal carbide particles and from 9 to 11 weight percent of a metallic binder based on total weight of the slurry; spray drying the slurry to form a powder; sintering a first portion of the powder; milling and sieving the first portion of the powder to a D50 of from 15 μm to 45 μm; and sintering the first portion of the powder for a second time in a partial liquid state to form a first mode;
forming a second mode by milling a second portion of the powder form non-spherical cemented carbide particles having a D50 of from 5 μm to 15 μm; and
combining the first mode and the second mode.

21. A binder jet printed sintered cemented carbide body comprising sintered cemented carbide particles comprising:
a first mode comprising spherical particles having a D50 of from 15 μm to 45 μm; and
a second mode comprising non-spherical particles having a D50 of from 5 μm to 15 μm, wherein the sintered cemented carbide particles comprise from 9 to 11 weight percent of a metallic binder based on total weight of the sintered cemented carbide particles, and the sintered cemented carbide body has a theoretical density percentage equal to or greater than 99%.

22. The sintered cemented carbide body of claim 21, wherein the sintered cemented carbide body has a sinter porosity rating of A02B00C00, A01B00C00, or A00B00C00.

23. The sintered cemented carbide body of claim 22, wherein the sintered cemented carbide particles comprise tungsten carbide, and the metallic binder comprises cobalt.

24. The sintered cemented carbide body of claim 23, wherein sintered density is greater than 14.0 g/cm³.

25. The sintered cemented carbide body of claim 21, comprising from 9.5 to 10.5 weight percent of the metallic binder based on total weight of the sintered cemented carbide particles.

26. The sintered cemented carbide body of claim 21, wherein the first mode has a D10 of from 10 μm to 25 μm, and a D90 of from 25 μm to 55 μm.

27. The sintered cemented carbide body of claim 21, wherein the second mode has a D10 of 0.5 μm to 5 μm, and a D90 of 10 μm to 30 μm.

28. The sintered cemented carbide body of claim 21, wherein the second mode has a particle porosity of no more than 20 volume percent.

29. The sintered cemented carbide body of claim 21, wherein the sintered cemented carbide body comprises from greater than 60 to less than 40 weight percent of the first mode based on total weight of the sintered cemented carbide body.

30. The sintered cemented carbide body of claim 21, wherein the sintered cemented carbide body comprises from greater than 25 to less than 40 weight percent of the first mode based on total weight of the sintered cemented carbide body.

31. A method of forming the sintered cemented carbide body of claim 21 comprising:
binder jet printing a powder composition comprising the sintered cemented carbide particles to form a green body; and
sintering the green body to provide the sintered cemented carbide body.

32. A method of forming a sintered cemented carbide body comprising:
binder jet printing a powder composition comprising sintered cemented carbide particles comprising a first mode comprising spherical sintered cemented carbide particles having a D50 of from 15 μm to 45 μm; and a second mode comprising non-spherical cemented carbide particles having a D50 of from 5 μm to 15 μm, wherein the sintered cemented carbide particles comprise from 9 to 11 weight percent of a metallic binder based on total weight of the sintered cemented carbide particles, and the sintered cemented carbide body has a theoretical density percentage equal to or greater than 99% and a printing binder to form a green body; and
sintering the green body to provide the sintered cemented carbide body.

33. The method of claim 12, wherein the green body is sintered by a sinter-HIP process.
